(19) United States
(12) Patent Application Publication
(10) Pub. No.: US 2002/0091666 A1
(43) Pub. Date: Jul. 11, 2002

(54) Method and system for modeling biological systems

(76) Inventors: John Jeremy Rice, Mohegan Lake, NY (US); Gregory Scott Lett, Hightstown, NJ (US)

Correspondence Address: PHYSIOME SCIENCES, INC., 150 COLLEGE ROAD WEST, PRINCETON, NJ, 08540, US

(21) Appl. No.: 09/898,151

(22) Filed: Jul. 3, 2001

Related U.S. Application Data
(60) Provisional application No. 60/216,876, filed on Jul. 7, 2000.

(51) Int. Cl. G06F 7/00

(52) U.S. Cl. 707/1

(57) ABSTRACT

The present invention relates to a method and system for quantitative and semi-quantitative modeling of biological and physiological systems. More specifically, the invention relates to the use of overlays to store and manipulate computational biological models. Also provided by the invention are methods and systems for preparing overlays, methods and systems for creating new computational biological models by applying overlays to old models, and computer program products comprising overlays.

### CROSS-REFERENCE TO RELATED APPLICATION

This application claims the benefit of priority of provisional U.S. patent application Ser. No. 60/216,876, filed Jul. 7, 2000, which is incorporated herein by reference.

### BACKGROUND OF THE INVENTION

1. Field of the Invention

The present invention relates generally to a method and system for quantitative and semi-quantitative modeling of biological systems.

2. Description of Background Art

As part of the drug discovery process, increasing amounts of DNA sequence data, RNA expression data, protein expression data, and other types of data are being generated. In particular, recent breakthroughs in developing automated methods of obtaining gene expression and protein expression data (including microarray-based technology) have allowed researchers to collect vast amounts of new data. Indeed, DNA sequence, RNA expression and protein expression data sets are being generated at rates that vastly exceed the research community's ability to interpret them.

Researchers need to store, analyze, link, and compare heterogeneous data from many sources, including in-house databases, public databases, and private content-providers. Commonly used public databases of sequence analysis data include: CCSD (Complex Carbohydrate Structural Database); EMBL (nucleic acid sequences from published articles and by direct submission, sponsored by the European Molecular Biology Laboratory); GenBank (nucleic acid sequences, sponsored by the National Institute of General Medical Sciences (NIGMS), NIH and Los Alamos Laboratory); GenInfo (nucleic acid and protein sequences, sponsored by the National Center for Biotechnology Information (NCBI) and NIH); NRL_{—}3D (protein sequence and structure database); PDB (protein and nucleic acid three-dimensional structures); PIR/NBRF (protein sequences, sponsored by the National Library of Medicine (NLM)); OWL (protein sequences consolidated from multiple sources, sponsored by the University of Leeds and the Protein Engineering Initiative); and SWISS-PROT (protein sequences, sponsored by the University of Geneva).

Furthermore, researchers need analytical tools to analyze and make sense of the mountains of bioinformatics data currently being generated. In particular, researchers need, and are increasingly making use of, highly detailed computer simulations of biological or physiological systems. These models can be used to describe and predict the temporal evolution of various biochemical, biophysical and/or physiological variables of interest. Accordingly, these simulation models have great value both for pedagogical purposes (i.e., by contributing to our understanding of the biological systems being simulated) and for drug discovery efforts (i.e., by allowing in silico experiments to be conducted prior to actual in vitro or in vivo experiments).

Coupling these detailed computer simulation models with the aforementioned automated sequencing techniques (and the volumes of data generated using these techniques) should increase the fidelity of the simulation models, thereby allowing for more accurate predictions of the dynamics of the biological/physiological system in question. Hence, there is a need for methods that systematically incorporate gene- and protein-expression data into predictive biological simulation models.

Existing techniques for analyzing gene-expression data fall into a handful of categories, including: (1) visual inspection of simple scatter plots; (2) cluster analysis; (3) principal component analysis; and (4) vector machine-learning algorithms (e.g., support vector machines (“SVMs”)). More recently, a software tool, Gene MicroArray Pathway Profiler (GenMAPP), for visualizing gene-expression data on maps of known metabolic and signaling pathways has been developed (see http://gladstone-genome.ucsf.edu/introduction.asp/). The aforementioned techniques allow researchers to visualize and manipulate gene-array data, and to analyze the data qualitatively (e.g., by identifying groups of functionally related genes), but do not provide a means for making quantitative predictions about the biological or physiological system of interest.

The most popular method for analyzing gene-expression data—cluster analysis—essentially seeks to group together genes with similar expression profiles (i.e., expression levels over time of the genes are correlated in some fashion). The expression profile for a particular gene can be represented by a vector, the kth element of which corresponds to the expression level of that gene at time tₖ. In order to determine which gene-expression profiles are “similar,” one must first choose a “distance” metric that measures how similar two expression profiles are. A simple distance metric is the Euclidean distance metric or L2 norm (i.e., the square root of the sum of the squares of the differences in expression levels for the two genes at corresponding time points). Another distance metric is Pearson correlation metric, which is equivalent to calculating the Euclidean distance metric after each gene-expression vector is normalized to unit length before the calculation. A drawback of the Pearson correlation is that it is sensitive to outliers in the data, and frequently produces false positives (i.e., indicating that two genes are co-expressed or correlated when the expression levels of the two patterns are unrelated in all but one time point where there is a significant peak or trough). Many other distance metrics may also be suitable depending upon the particular application, including the so-called “jackknife” correlation, which has been shown to be robust with respect to single outliers (thereby reducing the number of false positives). See—L. J. Heyer, “Exploring Expression Data: Identification and Analysis of Co-Expressed Genes,” Genome Res., vol. 9, pp. 1106-15 (1999); S. Tavazoie et al., “Systematic Determination of Genetic Network Architecture,” Nat. Genet., vol. 22, pp. 281-85 (1999).

Numerous algorithms and approaches to clustering analysis have been developed, including: (1) agglomerative hierarchical clustering (see, e.g., M. B. Eisen et al., “Cluster Analysis and Display of Genome-Wide Expression Patterns,” Proc. Natl. Acad. Sci. USA, vol. 95, pp. 14863-68 (1998); X. Wen et al., “Large-Scale Temporal Gene Expression Mapping of Central Nervous System Development,” Proc. Natl. Acad. Sci. USA, vol. 95, pp. 334-39 (1998)); (2) divisive hierarchical clustering (see, e.g., U. Alon et al. “Broad Patterns of Gene Expression Revealed by Clustering Analysis of Tumor and Normal Colon Tissues Probed by Oligonucleotide Arrays,” Proc. Natl. Acad. Sci. USA, vol. 96, pp. 6745-50 (1999); C. M. Perou et al., “Distinctive Gene Expression Patterns in Human Mammary Epithelial Cells and Breast Cancers,” Proc. Natl. Acad. Sci. USA, vol. 96, pp. 9212-17 (1999)); (3) self-organizing map (SOM) analysis (see, e.g. T. Kohonen, Self-Organizing Maps (Berlin: Springer, 1995); P. Tamayo et al. “Interpreting Patterns of Gene Expression with Self-Organizing Maps: Methods and Application to Hematopoietic Differentiation,” Proc. Natl. Acad. Sci. USA vol. 96, pp. 2907-12 (1999); P. Toronen et al. “Analysis of Gene Expression Data Using Self-Organizing Maps,” FEBS Lett., vol. 451, pp. 142-46 (1999)); and (4) k-means clustering (see, e.g., B. Everitt, Cluster Analysis, p. 122 (London: Heinemann, 1974)).

Notably, several patents directed toward clustering analysis techniques have recently been issued, including U.S. Pat. No. 5,729,662 (Neural Network for Classification of Patterns with Improved Method and Apparatus for Ordering Vectors); U.S. Pat. No. 6,012,058 (Scalable System for K-Means Clustering of Large Databases); and U.S. Pat. No. 6,203,987 (Methods for Using Co-Regulated Genesets to Enhance Detection and Classification of Gene Expression Patterns). In addition, cluster analysis software is now widely available, including free software such as the software that may be downloaded from: http://genome-www.stanford.edu/˜sherlock/cluster.html; and http://rana.lbl.gov/EisenSoftware.htm.

While the above-enumerated techniques for analyzing gene-expression data are useful and, indeed, valuable for studying and characterizing biological systems, they cannot be used directly to make predictions as to how a particular biological system will behave under a particular set of conditions. Moreover, neither cluster analysis nor any of the above-listed methods for analyzing gene-array data is capable of forecasting the temporal evolution of a biological or physiological system.

Furthermore, current approaches to predictive modeling of biological and physiological systems do not utilize gene- or protein-expression data or, at best, take such data into account in a quite limited fashion. Even those biological and physiological simulation systems that are able to take into account expression data are not capable of automatically and systematically updating or adjusting the model structure or parameters based upon such data.

Another disadvantage of these simulation systems is that models of complex systems not only require greater computing power or CPU speed to simulate in a reasonable amount of time, but also require large memory or other storage capacity to save/store these models. Moreover, if a researcher is interested in developing a number of models of the same biological system, the storage capacity needed will generally grow in proportion with the number of models created. What is needed therefore is a method for reducing the memory and/or storage costs of multiple, related models.

One example of an advanced biological simulation model is the computational model for simulating the electrical and chemical dynamics of the heart that is described in U.S. Pat. No. 5,947,899 (Computational System and Method for Modeling the Heart), which is incorporated herein by reference. This computational model combines a detailed, three-dimensional representation of the cardiac anatomy with a system of mathematical equations that describe the spatiotemporal behavior of biophysical quantities, such as voltage at various locations in the heart. Notably, the simulation model disclosed in the patent does not utilize or incorporate gene- or protein-expression data, nor does the model provide for an efficient method for storing multiple, related models.

Further examples of biological simulation software for modeling of biological and physiological systems include: DBsolve (see I. Goryanin et al., “Mathematical Simulation and Analysis of Cellular Metabolism and Regulation,” Bioinformatics, vol. 15, pp. 749-58 (1999)); GEPASI (see P. Mendes & D. Kell, “Non-Linear Optimization Of Biochemical Pathways: Applications to Metabolic Engineering and Parameter Estimation,” Bioinformatics, vol. 14, pp. 869-83 (1998); P. Mendes, “Biochemistry By Numbers: Simulation of Biochemical Pathways with GEPASI 3,” Trends Biochem. Sci., vol. 22, pp. 361-63 (1997); P. Mendes & D. B. Kell, “On the Analysis of the Inverse Problem of Metabolic Pathways Using Artificial Neural Networks,” Biosystems, vol. 38, pp. 15-28 (1996); P. Mendes, “GEPASI: A Software Package for Modeling the Dynamics, Steady States and Control of Biochemical and Other Systems,” Comput. Appl. Biosci., vol. 9, pp. 563-71 (1993)); NEURON (see M. Hines, “NEURON: A Program for Simulation of Nerve Equations,” Neural Systems: Analysis and Modeling (F. Eeckman, ed., Kluwer Academic Publishers, 1993)); GENESIS (see J. M. Bower & D. Beeman, The Book of GENESIS: Exploring Realistic Neural Models with the General Neural Simulation System, (2d ed., Springer-Verlag, New York, 1998)).

Numerous other simulation packages have been applied to modeling biological and physiological systems including: Talis (a visual and interactive real-time tool for simulating metabolic pathways, gene circuits and signal transduction pathways); NetWork (a Java applet for interactive simulation of genetic networks); SCAMP (a command-line driven software package running on the Atari ST and MS-DOS operating systems; capable of simulating steady-state and transient behavior of metabolic pathways and calculation of all metabolic control analysis coefficients); MIST (a biological pathway simulation package running on MS Windows 3.1); MetaModel (MS-DOS-based software package for steady-state simulation of metabolic pathways); SCoP (a commercial simulation program that can be used to simulate metabolic systems); CONTROL (a DOS-based software package that uses the Reder matrix method to calculate control coefficients from elasticity values); MetaCon (a DOS-based metabolic control analysis program available at ftp://bmshuxley.brookes.ac.uk/pub/software/ibmpc/metacon); BioThermo (a simulation package that calculates the feasibility of individual pathway reactions based upon Gibbs free energy values and metabolite concentrations); FluxMap (a simulation package that calculates metabolic fluxes based on metabolite balancing); BioNet (a metabolic flux analysis package); and the Matlab Simulink and Stateflow simulation packages.

Notably, none of the other abovementioned simulation software packages currently provide for the systematic incorporation of gene- or protein-expression data into the simulation models, nor do any of the software packages have the capability of efficiently storing multiple, related models.

### SUMMARY OF THE INVENTION

In accordance with the present invention, there is provided a method and system for storing and saving computational biological models using overlays. Advantageously, use of overlays can reduce the memory and storage requirements for manipulating multiple, related biological simulation models.

There is also provided a method and system for creating overlays. In one embodiment, the method for creating overlays comprises comparing two existing computational biological models and storing the differences between the second model and the base model as an overlay. The second model can later be recreated by applying the overlay to the base model. In another embodiment, the overlay is created directly based upon new information or data about the biological system being modeled.

In accordance with another aspect of the invention, there is provided a system and method for automatically generating new computational biological models from existing computational biological models based upon experimental data or other information. More specifically, an overlay is generated based upon the new data/information; and subsequently, the overlay is applied to an existing computational biological model to generate a new model that thereby takes into account the new data/information.

In accordance with yet another aspect of the invention, there is provided a method and system for systematically incorporating gene and protein expression data into a computational biological model. In one embodiment, the computational biological model is a model of a cell during various phases of the cell cycle. In another embodiment, the computational biological model is a model of the heart or a portion of the heart.

Also provided is a method and system for incorporating information into a computational biological model in a hierarchical manner, said method comprising the steps of: creating a series of overlays; applying the series of overlays in sequence to a base computational biological model; and running a simulation of at least one of the computational biological models produced by applying the overlays.

Finally, also provided are computer program products comprising an overlay incorporated in a computer usable medium in a computer readable format. Preferably, the overlay is represented in an extensible mark-up language (XML). Also provided are computer program products, comprising computer readable code means for causing a computer to execute the steps of the above-described methods.

Further features, aspects and advantages of the present invention will become apparent from the drawings and description contained herein.

### BRIEF DESCRIPTION OF THE DRAWINGS

The invention will be more fully understood and further advantages will become apparent when reference is made to the following detailed description and the accompanying drawings in which:

FIG. 1 is a diagram depicting some of the hardware components of one embodiment of the invention;

FIGS. 2a and 2b are flow charts of the process steps in certain embodiments of the invention;

FIG. 3 is a diagram depicting the phases of the cell cycle;

FIGS. 4 through 6 are screenshots from a biological modeling software package, showing some equations from a cardiac model; and

FIG. 7 is a graph of cell membrane voltage as simulated by a biological modeling software package.

### DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

The present invention relates to a method of using “overlays” (described in more detail below) to manipulate and store models of biological and/or physiological systems. (As used herein, the term “biological system” encompasses and includes physiological systems.) Such models of biological and/or physiological systems are often referred to as computational biological models; and such models can describe events at different levels of the system being modeled, ranging from the subcellular level (e.g., biochemical reaction networks) to the cell level to the organ or tissue level to the whole organism level (and perhaps higher, as in population model).

The term “computational biological model” (“CBM”), in the most general sense, refers to a mathematical system of equations that describe a biological process or entity (e.g., reaction, cell, organ, tissue, organism). For purposes of illustration, the examples used in this patent application will assume that the system of equations underlying the CBM is a system of ordinary differential equations (ODEs). However, more complex CBMs can include partial differential equations (requiring more sophisticated numerical algorithms for solution), and very simple CBMs can be modeled entirely using a system of algebraic equations. Other types of CBMs also include, inter alia, stochastic models (e.g., a system of stochastic differential equations), finite-difference models (i.e., when one or more variables are discrete rather than continuous), and/or Boolean (or binary) network models. In a CBM, the underlying system of equations describes a set of variables that completely determine the current state of a biological system (at least insofar as the variables of interest to the scientist-modeler and/or the experimentally observable variables are concerned). Such a system is commonly referred to as a state-equation representation.

For a typical state-variable model, the model can be decomposed into three types of components: (1) the equations that describe the possible states of the system (i.e., state equations); (2) the parameters in these equations; (3) and the initial values for the state variables, as well as any applicable boundary conditions (i.e., initial conditions and/or boundary conditions). Fully describing each of the three components uniquely specifies a particular model. For certain types of models, there may be additional “components” that may be specified, such as the topology of the system being modeled (e.g., when modeling a biochemical reaction pathway).

An overlay can be viewed as a subset of one or more model components (e.g., state equations, parameters and/or initial conditions/boundary values) that does not by itself necessarily constitute a CBM, but can be “overlaid” on (or applied to) an existing CBM to produce a new CBM. (In certain instances, an overlay may itself be a self-contained CBM capable of generating simulation predictions, but, in the general case, an overlay need not be a complete CBM.) An overlay can also be viewed as the set of all information necessary to specify the differences between two models. Hence, the combination of Model A with an overlay representing the differences between Models A and B can be used to determine Model B uniquely. The overlay itself, however, does not fully describe either Model A or Model B.

One convenient approach to implementing the overlay method is to represent models and overlays using Extensible Mark-Up Language (XML), a standard maintained by the Worldwide Web Consortium. XML is a simple dialect of SGML or Standard Generalized Markup Language (ISO 8879:1985), the international standard for defining descriptions of the structure of different types of electronic documents. In essence, XML is a ‘metalanguage’—or a language for describing other languages—which allows for flexible implementation of various customized markup languages for numerous different types of applications. XML is designed to make it easy and straightforward to author and manage various data files, and to transmit and share them across the Web. However, XML is not just for Web pages, and can be used to store any kind of structured information, and to enclose or encapsulate information in order to pass it between different computing systems that would otherwise be unable to communicate.

In a preferred embodiment of the invention, CellML, a subset of XML, is used to describe the CBMs at the cell level (and MathML to describe the underlying mathematical equations). In another preferred embodiment, the CBMs are described partially using CellML and partially using another XML, such as AnatML or FieldML.

The CellML language is an XML-based markup language, which was developed by Physiome Sciences, Inc. (Princeton, N.J.), in conjunction with the Bioengineering Research Group at the University of Auckland's Department of Engineering Science and affiliated groups. CellML was specifically designed to store and exchange CBMs. CellML includes information about model structure (i.e., how the parts of a model are organizationally related to one another), mathematics (i.e., the equations describing the underlying biological processes) and metadata (i.e., additional information about the model that allows scientists to search for specific models or model components in a database or other repository). The contents of each CellML file must conform to a set of grammar rules defined in the CellML Document Type Definition (DTD) (see http://www.esc.auckland.ac.nz/sites/physiome/cellml/public/specification/appendices.html).

### Overlay Method Reduces Memory/Database Storage Needs

CBMs are typically stored in relational databases. As the size of individual CBMs grow to encompass thousands or millions of state equations in a single model, the overhead cost of storing such models may become substantial. Overlays provide a convenient method for storing a related sequence of CBMs at considerably lower storage costs. Even if the cost of disk storage is not an issue, the overhead of retrieval from data vaults may be considerable. Additionally, a user may wish to load and manipulate several CBMs in memory at once. If a single complete CBM is stored in memory, while related CBMs are generated as needed using overlays, then the computer-memory requirement for storing all models will be considerably reduced as a consequence.

For example, consider a sequence of CBMs that represent the time evolution of a disease process X in a cell type Y. Assuming that one tracks the disease process every day for a year, one could generate a sequence of models YX₁, YX₂, . . . , YX₃₆₅, where YXₙ represents a model of disease process X in a cell type Y on day n. Using the overlay method, one would generate a base model Y and n overlays; each model YXₙ could then be generated by applying overlay x to base model Y: YXₙ=xₙ*Y. If the size of each overlay xₙ is small compared to the corresponding complete model YXₙ, then considerable savings in storage and memory will result. For instance, if the mean storage requirement for a complete model YXₙ were 10 MB/model, then storing all 365 models would impose a total memory cost of 3.65 GB. However, if only 10% of the model components are altered by the disease, then the average storage requirement for overlay xₙ is 1 MB, and the cost of storing one base model plus 365 overlays is 375 MB or 0.370 GB (about one-tenth the requirement for storing 365 complete models). An even more compact representation might be achieved using sequentially applied overlays, where the nth model can be computed by applying n successive overlays to the base model: YXn=xₙ*xₙ₋₁* . . . x₁*Y. Assuming that only 1% of model components are altered by the disease from day to day, then the average size of each overlay xₙ is 0.1 MB, and the cost of storing one model and 365 overlays is 46.5 MB or 0.0465 GB (or about 1.3% of the storage requirement for storing all 365 complete models).

### Description of Overlay Algebra

It is possible to apply multiple overlays in sequence. For example, after overlay x is applied to a base model A to construct a new model B, a second overlay y could applied to model B to generate another new model C. The application of multiple overlays is governed by an “algebra” or set of rules, which are summarized in the table below. (The following conventions are used: bold upper case letters designate models and bold lower case italics designate overlays. Also, “−” refers to a context-specific differencing of two models and not simply a binary subtraction operation.)

| | | |
|---|---|---|
| B − A = x | Overlay x is defined as the difference between | 1 |
| | model B and model A. | |
| xA = B | Overlay x can be applied to a model A to generate | 2 |
| | model B. | |
| C − B = y | Overlay y is defined as the difference between | 3 |
| | model C and model B. | |
| yxA = C | First overlay x is applied to a model A to generate | 4 |
| | model B, overlay y is applied to a model B (= xA) | |
| | to generate model C. | |
| yC = yxC = C | Applying overlay y or x then y to model C has no | 5 |
| | effect. | |
| in general | Overlays are not commutative. Changes to model | 6 |
| yxA · xyA | are applied in order of application of overlay. yxA | |
| | could but does not have to be equivalent to xyA. | |
| C − A = z | Overlay z is the difference between model C and | 7 |
| | model A. | |
| z = w iff | Equivalent overlays must produce equivalent | 8 |
| zD = wD | models when applied to any base model. For | |
| for any | example, by definition (4) and (7), zC = xyC for | |
| model D | model C, but a similar relation is not known in | |
| | general for all models. | |
| if x · y = Ø | If overlay y and/or x modify a disjoint set of model | 9 |
| then | components, then these overlays are commutative. | |
| yxA = xyA | | |
| yxA = xyA | Consider that the intersection of overlay x and | 10 |
| does not | overlay y may be non-empty, but common | |
| require | component modification may affect model A in a | |
| x · y = Ø | similar way. | |
| xy = r then | Overlay x can be applied to y to produce new | 11 |
| rA = C | overlay r. Now applying overlay r to model A | |
| | produces model C. | |

The above rules are generic in that they can be applied to a wide class of models including ODE systems, as well as other systems of equations such as partial differential equations (PDEs), binary networks, or combined representations.

### Computer Hardware

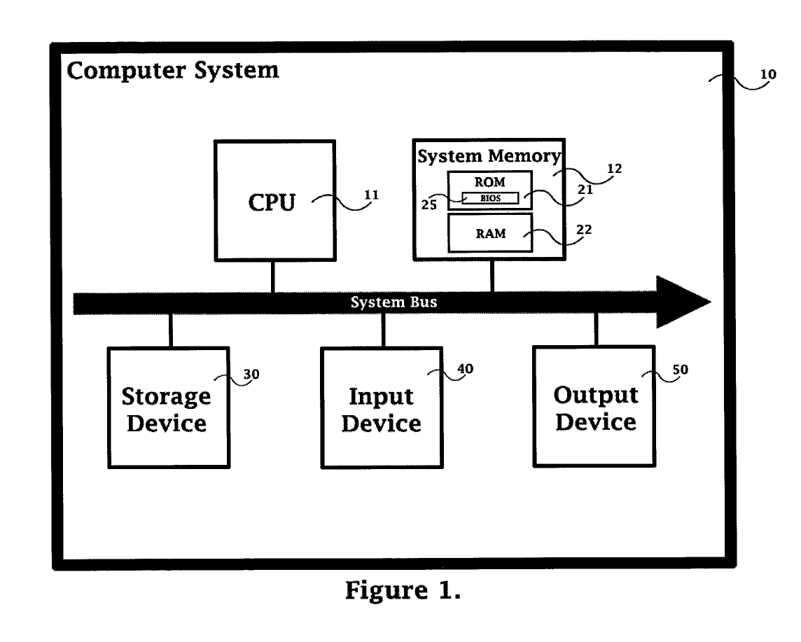

FIG. 1 depicts an exemplary computer system for practicing the invention. Referring to FIG. 1, the exemplary computer system comprises a general purpose computing device 10, including one or more processing units or CPUs 11, a system memory 12, and a system bus 13 that connects various system components (such as the system memory 12) to the processing unit(s) 11. Any one of a variety of bus architectures (including ISA, MCA, AGP, USB, AMR, CNR, PCI, Mini-PCI, and PCI-X) may be used.

The system memory 12 includes both read-only memory (ROM) 21 and random access memory (RAM) 22. A Basic Input/Output System (BIOS) 25, containing basic software routines, including those needed during start-up, is stored in ROM 21.

The exemplary computer system also includes a storage device 30 providing nonvolatile storage of computer programs (including operating system programs and application programs), data, and other electronic files. Although the primary storage device typically used is a hard disk drive, numerous other storage devices may be used instead of, or in addition to, a hard disk drive, including: optical disks (e.g., CD ROM); removable magnetic disks; Bernoulli cartridges; digital video disks; magnetic tapes or cassettes; flash memory cards; and various other storage devices familiar to the skilled artisan.

Data and/or commands may be entered using an input device 40. The primary input device is typically a keyboard and/or pointing device (such as a mouse). However, numerous other input devices may be used instead of, or in addition to, a keyboard and pointing device, such as: joysticks; microphones; satellite dishes; scanners; video cameras; and other devices known to those skilled in the art. The input device is typically connected to the bus 13 or to the processing unit 11 through some interface, such as a serial port, a parallel port or USB port. Advantageously, gene array or other data may be ported directly to the computer. Special purpose hardware devices are currently available to read, analyze and export gene-array data to desktop workstations (e.g., the GeneChip® instrument systems sold by Affymetrix (Santa Clara, Calif.), see http://www.affymetrix.com).

The exemplary computer system also includes an output device 50, typically a monitor or other display terminal connected to the bus. Other peripheral output devices may also be used, including printers and speakers.

The exemplary computer system may be operated in a networked environment or on a standalone basis. If operated in a networked environment, the computer system may be connected to one or more remote computers in a local area network (LAN) using network adapter cards and Ethernet connections, or in a wide area network (WAN) using modems or other communications links.

### The Base Simulation Model

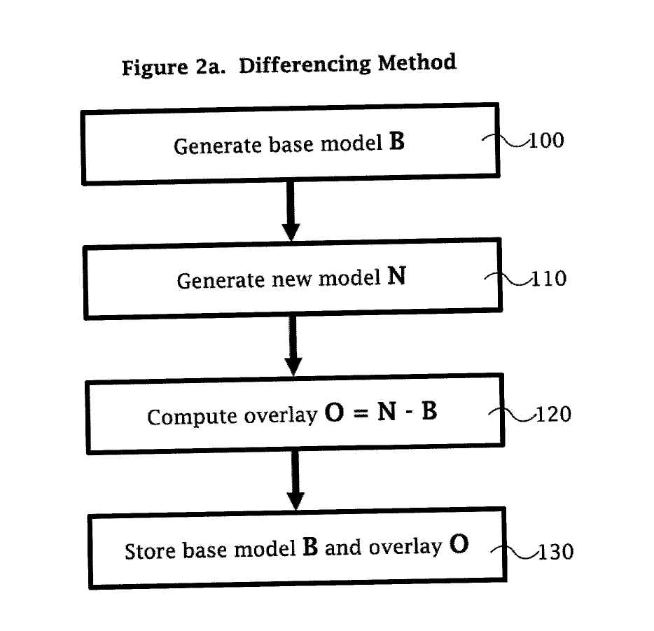

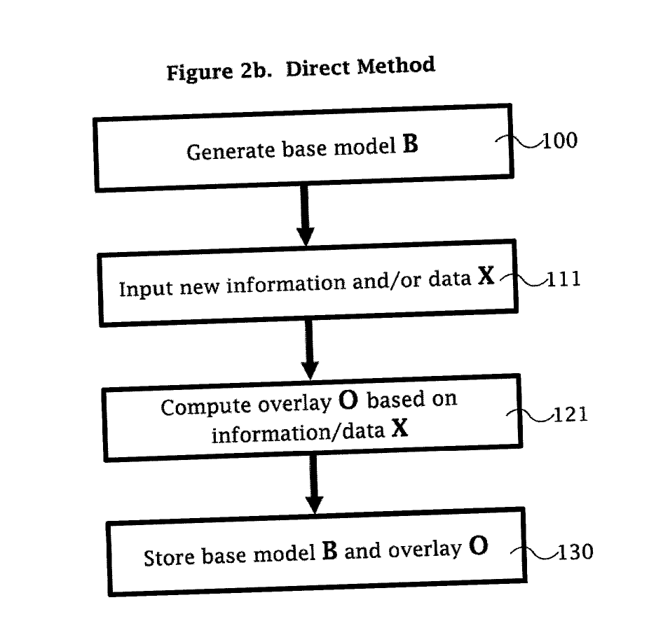

The overlay method does not generate a model de novo, but rather requires at least one preexisting base model. The base model may be generated using any one of a number of approaches and/or software tools, which are familiar to the skilled artisan. FIGS. 2a and 2b depict the base model generation step 100.

One example of a very sophisticated biological modeling platform is the In Silico Cell™ modeling environment developed by Physiome Sciences, Inc. (Princeton, N.J.). The In Silico Cell™ modeling platform, which allows biological-systems modelers to create computational models of subcellular, cellular and intercellular systems and processes, is described in more detail in U.S. patent application Ser. Nos. 09/295,503 (System and Method for Modeling Genetic, Biochemical, Biophysical and Anatomical Information: In Silico Cell); 09/499,575 (System and Method for Modeling Genetic, Biochemical, Biophysical and Anatomical Information: In Silico Cell); Ser. No. 09/599,128 (Computational System and Method for Modeling Protein Expression); and Ser. No. 09/723,410 (System for Modeling Biological Pathways), which are each incorporated herein by reference.

A biological simulation system that explicitly allows for spatial modeling of cells is the Virtual Cell, a software package developed at the University of Connecticut. The Virtual Cell™ program and its capabilities is described in some detail in the following references: J. C. Schaff, B. M. Slepchenko, & L. M. Loew, “Physiological Modeling with the Virtual Cell Framework,” in Methods in Enzymology, vol. 321, pp. 1-23 (M. Johnson & L. Brand, eds., Academic Press, 2000); J. Schaff & L. M. Loew, “The Virtual Cell,” Pacific Symposium on Biocomputing, vol. 4, pp. 228-39 (1999); J. Schaff et al., “A General Computational Framework for Modeling Cellular Structure and Function,” Biophys. J., vol. 73, pp. 1135-46 (1997); and C. C. Fink et al., “An Image-Based Model of Calcium Waves in Differentiated Neuroblastoma Cells,” Biophys. J., vol. 79, pp. 163-83 (2000). The Virtual Cell program and some of its underlying algorithms are also described in U.S. Pat. No. 6,219,440 (Method and Apparatus For Modeling Cellular Structure and Function), which is incorporated herein by reference.

Numerous other systems and methods for creating predictive models of biological and physiological systems are well known in the art. The selection of a suitable method for creating a base model will depend upon the nature of the system being modeled, but is well within the skill of the ordinary artisan. Preferably, the modeling platform or method generates models in CellML or another XML format.

### Creating an Overlay

Two complementary methods exist for creating overlays. The first method comprises computing the overlay as the “difference” between two existing models; this method is depicted in FIG. 2a. The second method involves to constructing the overlay directly based upon experimental or other data; this method is depicted in FIG. 2b. These two methods are described in detail below.

### Differencing Method

Given any two non-identical models, an overlay can be created by comparing the two models to detect any differences between the two models. Referring to FIG. 2a, the second model may be generated 110 using the same model generation technique used to create the base model. The overlay creation step 120 involves comparing the two models on a character-by-character (or byte-by-byte) basis or at some higher level of abstraction.

Preferably, the comparison is done at a level that will reveal actual structural differences between the models (e.g., differences that will affect the control flow of the compiled code). From a biological modeling standpoint, only biologically significant differences between the CBMs should be stored in an overlay, and two models that produce identical compiled code should be deemed identical from a modeling perspective. A string comparison (or bitwise comparison) approach, as is typically used in software version-tracking programs, will result in spurious or biologically insignificant “differences” being stored in the overlay.

Comparison of two or more models can also serve a pedagogical purpose in terms of elucidating the underlying biology or physiology of the system being modeled. For example, if two CBMs have been developed independently to model the same system in different states (e.g., diseased versus normal, quiescent versus mitotic, exposure to a drug versus no exposure), a comparison of the two models may reveal the underlying biological/biochemical triggers that induce the system to transition between the two states. This will not only increase our understanding of the system being modeled but may also be invaluable in identifying drug targets or possible treatments/interventions for particular diseases.

There are a variety of ways to measure the differences between models. Standard text-editing tools, such as the POSIX “diff” program (or variants such as “ediff” and “gnudiff”), identify text-based differences between two text files or buffers in memory. Source-code management systems for software development (e.g., CVS, RCS, SCCS, Microsoft SourceSafe) make use of this program to store multiple versions of a changing software program by storing one version and the differences between versions. Such a method can be applied to computational biological models stored as text.

Some biological modeling software, such as Physiome's In Silico Cell platform, use an XML-representation for manipulating and storing computation biological models. Because XML is an ordinary text-based markup language, the above-described text-based differencing can be applied.

Preferably, the “differencing” is performed at a level of abstraction higher than the text level; the identified differences should reflect structural or biologically significant differences between the models being compared. In such a situation, the differencing methodology or algorithm used will likely be more domain-specific (i.e., make use of a priori information about the type/structure of the model to help define the differences between models). For example, in a CBM including models of geometric structures, a user may be able define structures in terms of specified shapes and dimensions and may be able to revise/edit geometric structures using high-level commands such as “add a substructure,” “delete a substructure,” “move a structure to a new location,” or “change the shape of a structure”; the differencing methodology used may track differences in terms of the high-level commands necessary to transform the geometric structure specified in one model versus the structure specified in a base model. Similarly, differences between CBMs including models of biochemical reactions can be tracked at the level of differences between two models in terms of reactant and product species, concentrations and kinetic rate constants.

Finally, as shown in step 130 of FIG. 2a, the base model and computed overlay are both stored. The choice of a particular representation of the differences stored in the overlay (as well as the representation of the base model itself) will likely depend upon such requirements as compactness, intuitive communication of differences to a user and/or computational efficiency.

Storing the models in XML format will facilitate comparison of models in a more straightforward manner, as will stringent variable naming and typing conventions. If modelers (or programmers) adhere to the syntax conventions set forth in the Document Type Definition (DTD) for the XML language, structurally similar models stored in XML format will necessarily be similar on a text-level basis. Even DTD-less XML files, as long as they are well formed, will have a structure that facilitates straightforward comparison of models. For these reasons, both models and overlays are preferably stored in an XML format such as CellML.

### Direct Method

Although the most straightforward approach to creating an overlay is by direct comparison of two existing CBMs, it is also possible to create an overlay directly (as depicted in steps 111 and 121 in FIG. 2b). For example, if the second model differs from the base model only in the values of certain parameters, one may directly create an overlay that when applied to the base model will change the appropriate parameters to their new values. Again, as in the differencing method, it is only necessary to store 130 the base model and the overlay.

In a preferred embodiment, the overlay is generated based upon experimental data. For example, a base model may have as a component a particular enzyme-catalyzed reaction known or hypothesized to exhibit Michaelis-Menten kinetics. Perhaps initially, one had only estimates or guesses of the Kₘ and Vₘₐₓ values for this enzyme (e.g., based on values reported in the literature for similar enzymes); and these “best guess” values were used as parameters in the initial or base model. Subsequently, one might obtain experimental data that could be used to calculate Kₘ and Vₘₐₓ values. An overlay could then be created that reflects the experimentally derived Kₘ and Vₘₐₓ values.

Another approach to using experimental data in the overlay creation process is to modify a base model in such a manner as to minimize some error metric measuring the difference between predictions made by the model and a set of experimental measurements of one or more variables of the system being modeled. The error-minimization and candidate-model-selection process may be constrained or unconstrained, and may involve changes in parameters only or may include structural changes to the model. One technique for adjusting a model based on image data is described in Provisional U.S. patent application Ser. No. 60/275,287 (Biological Modeling Utilizing Image Data), which is incorporated herein by reference. Once a new model is derived from the base model, one may generate an overlay by identifying the differences between the two models, as described above.

### Comparison and Selection of Candidate Models

When selecting between or among two or more computational biological models, it is necessary to determine which model is better suited for a particular purpose. An objective assessment of the “quality” of a model will often include a determination as to which model more accurately predicts the outcome of an experiment (or experiments). In order to make such a determination, one must have some measure of the goodness-of-fit between model-forecasted results and the experimental data. Such measures may be deterministic (e.g., L2 norm) or statistical (e.g., measuring the probability that one model is a better representation than another). Other measures of model quality include the simplicity of the model (in terms of structure, number of variables, etc.), availability of software and hardware needed to simulate using that model, and understandability for users of the model.

### EXAMPLE 1

### Incorporation of Genomic and Proteomic Data into CBMs

Advances in gene array and protein array technology have revolutionized the study of gene and protein expression. See, e.g., P. O. Brown & D. Botstein, “Exploring the New World of the Genome With DNA Microarrays,” Nature Genet., vol. 21 (Suppl.), pp. 33-37 (1999). These automated data collection techniques allow researchers to evaluate patterns of gene and protein expression on a genome-wide level.

Examples of automated methods include using ordered arrays of related entities such as oligonucleotides (DNA chip technologies), peptides (protein chip technologies), or drugs. Concomitant with the recent advances in technology for building microarrays, various analytical techniques have been developed, including techniques for identifying differentially expressed genes (amongst potentially thousands of genes that share the similar levels of activity) and for quantifying the expression levels of these genes.

Preferably, the data collected from these microarrays is stored in Microarray Markup Language (MAML) format. MAML, which is based on XML, provides a framework for describing and communicating information about a DNA-array experiment. MAML data structures include details about: (1) the experimental design (e.g., the set of the hybridization experiments as a whole); (2) the array design (e.g., each array used and each element (spot) on the array); (3) the samples used (and the procedures for extract preparation and labeling); (4) the hybridization procedures and parameters; (5) the measurements made (e.g., images, quantitation, specifications); and (6) the controls used (e.g., types, values, specifications).

MAML is independent of the particular experimental platform and provides a framework for describing experiments done on all types of DNA-arrays, including spotted and synthesized arrays, as well as oligonucleotide and cDNA arrays, and is independent of the particular image analysis and data normalization methods used. MAML is not limited to any particular image analysis or data normalization method. Instead, MAML provides a format for representing microarray data in a flexible way, thereby enabling researchers to represent data obtained from not only any existing microarray platforms, but also many of the possible future variants. The format allows representation of both raw and processed microarray data, and is compatible with the definition of the “minimum information about a microarray experiment” (MIAME) proposed by the MGED group, see http://www.mged.org.

In addition to MAML, other markup languages have been proposed for representing gene array data, including, for example, Gene Expression Markup Language (GEML™) (see http://www.geml.org), an XML-based tag set which was developed by Rosetta Inpharmatics to provide a standard protocol for exchanging gene expression data along with associated gene and experiment annotation. For purposes of creating an overlay, the exact format of the gene-array input data is unimportant. However, in a preferred embodiment as described herein, the use of both XML-based input and XML-based models will provide some commonality as between the input data and the resulting overlay.

The simplest use of microarrays involves measuring the absolute or relative level of mRNA in a population of cells. Generally, researchers have assumed that the level of mRNA approximates (or correlates with) the corresponding protein level in the cell. While this relationship may hold in some cases, the exact relationship between the expressed level mRNA and the corresponding level of functional protein is less certain. For any given gene, the amount of RNA accumulated in the cell at a given point in time is dependent on rates of transcription, RNA processing and export, and mRNA turnover (or catabolism). While the mRNA is the input for ribosomal translation, the final level of functional protein may depend on post-translational modification, intracellular transport, and degradation rates. Hence, functional protein levels depend on steps that cannot be assessed with current gene-array technologies.

When modeling signal pathways and other cellular processes, the key variable is the concentration of various proteins rather than the levels of mRNA coding for those proteins. To the extent that there are differences in translational efficiency or protein stability, the mRNA level may not be an accurate proxy for gene-product or protein levels. With this limitation in mind, many technologies are currently under development that will allow for more direct assessment of the protein content in cells.

Indeed, various technologies for automating the identification and measurement of constituent proteins are well known in the art. One example of such a technology is high-density, two-dimensional electrophoretic separation of proteins. The advantage of two-dimensional electrophoresis over one-dimensional electrophoresis is the much higher resolution achieved with the former method. Typically, in the first dimension, proteins are resolved according to their isoelectric points (pIs) using immobilized pH gradient electrophoresis (IPGE), isoelectric focusing (IEF), or non-equilibrium pH gradient electrophoresis (NEPHGE). Under standard conditions of temperature and urea concentration, the observed focusing points of the great majority of proteins using IPGE (and to a lesser extent IEF) closely approximate the predicted isoelectric points calculated from the proteins' amino acid compositions. In the second dimension, proteins are separated according to their approximate molecular weight using sodium dodecyl sulfate poly-acryl-amide-electrophoresis (SDS-PAGE).

The overlay method described herein can be applied in a straightforward manner to take advantage of these emerging proteomics technologies. However, for the examples described below, the less direct but currently more commonly used gene-array technologies are considered.

Currently, no standardized methods currently for systematic incorporation of genomic and proteomic data from automated arrays into CBMs. Gene and protein expression data, standing alone, are generally insufficient to create a CBM (without other a priori knowledge about the system being modeled). However, gene and protein expression data do provide essential information relating to an important subset of CBM model components. Hence, because overlays constitute, in essence, a subset of model components, using overlays are a natural way to integrate data that describe a subset of the CBM.

Moreover, as described above, overlays provide a natural means for incorporating modifications into CBMs in a hierarchical fashion. Indeed, the algebra defining sequential overlay operations provides a systematic means to incorporate data with ordered precedence. This ordered precedence is needed because genomic assays can generate overlapping data that suggest conflicting effects on model components. Conversely, different automated data collection methods can generate non-overlapping data (i.e., affecting different subsets of model components). Any automated system for incorporating large genomic/proteomic datasets into a CBM must be able to handle the complex ranking, filtering, and incorporation of genomic/proteomic data.

For example, consider a scenario where data is collected using two different methods: (1) gene array chips (Method GC); and (2) high-density, two-dimensional electrophoretic separation (Method 2dES). Assume that the Method GC data is used to compute an overlay p, and the Method 2dES data is used to compute an overlay q. Further assume that both overlay p and overlay q are applied to base model A to produce new models that reflect the incorporation of their respective data sets.

These different data sets could be simultaneously incorporated into a CBM using overlays by the following methods:

1. If Method GC and Method 2dES data describe changes to disjoint sets of model components (if p•q=∅), then overlay p and overlay q can be applied to base model A in either order (i.e., pqA=qpA). Because models and overlays include potentially thousands of components, automated methods must be used to insure the required condition that p•q=∅.

2. If one data set is deemed more accurate than the other, then a hierarchical method can be used. For example, assume that Method 2dES is more accurate than Method GC, and these methods provide data on some common model components (i.e. p•q•∅). In this case, overlay p is applied before overlay q to base model A. Changes in base model A produced by overlay p will override those of overlay q.

3. If both data sets are deemed suspect, then a correlation method can be used to incorporate consistent data from overlay p and overlay q. For example, assume that base model A should only be modified with data from Method 2dES that is consistent with data from Method GC. In this case, only components in both overlay p and overlay q (i.e. p•q) will be included. In addition, corresponding parameters and initial conditions of these equations would have to agree within some defined tolerance. In this case, a new overlay could be constructed using the common equations, the mean values of each parameter, and the mean values of each initial condition. Because models and overlays comprise potentially thousands of components, automated methods will be used to generate the new overlay from the initial overlays p and q.

4. A combination of the above methods may be used. For example, more than two overlays could be combined using a combination of the rules above.

In a preferred embodiment, the CBM is stored in the form of an extensible mark-up language (XML). CellML and other XMLs are especially suited for describing computational models and CBMs in particular. Furthermore, the overlay method is particularly suited to incorporating genomic/proteomic data into a hierarchical series of biological models constructed using XML.

Consider a biological reaction present in a living cell such as the binding of a ligand to a receptor on a cell surface. Assume that an XML (e.g., BiochemML) has been developed to facilitate the modeling of such biological reactions. Now consider that the same biochemical reaction may need to be represented in a model of a complete cell. In this case, the particular reaction may be an intermediate occurrence in a chain of events that ultimately results in a cellular response. Assume further that the cell model is represented using CellML, an XML designed specifically for modeling of cells. Because modeling cells may require taking into account more interactions that modeling simple biological reactions, CellML can be defined as a superset of BiochemML. Extending this to the organ level, an XML designed for modeling organs (OrganML) can be defined as a superset of CellML.

In the scenario described above, the modeled biological reaction (which is a CBM) occurs in a cell that is part of a larger organ. However, a hierarchical system for modeling, as proposed here, would allow for the same reaction to be represented whether the CBM is at the level of reaction, cell, or tissue. Moreover, assuming that the model of the initial ligand binding to a receptor is implemented in BiochemML, then any overlay modifying such a model would constitute a subset of a BiochemML model and hence would itself be implemented in BiochemML. The same overlay can then be applied without modification to a model of cell or a tissue that include the reaction of interest. Because the overlay is a subset of BiochemML (which is a subset of CellML and OrganML), the overlay may validly be applied to higher level CBMs as well as to the reaction-level CBM.

### EXAMPLE 2

### Incorporating Cell-cycle-dependent Protein-expression Data Using Overlays

It is known that a cell's gene expression profile changes in response to various growth factors and mitogens, and that different sets of genes are differentially expressed during different parts of the cell cycle. See, e.g., D. Fambrough et al. “Diverse Signaling Pathways Activated by Growth Factor Receptors Induce Broadly Overlapping, Rather Than Independent, Sets of Genes,” Cell, vol. 97, pp. 727-41 (1999); V. R. Iyer et al., “The Transcriptional Program in the Response of Human Fibroblasts to Serum,” Science, vol. 283, pp. 83-87 (1999); L. F. Lau & D. Nathans, “Identification of a Set of Genes Expressed During G0/G1 Transition of Cultured Mouse Cells,” EMBO J., vol. 4, pp. 3145-51 (1985). Gene array technology is particularly suited to studying induction of gene expression as a function of the cell cycle phase.

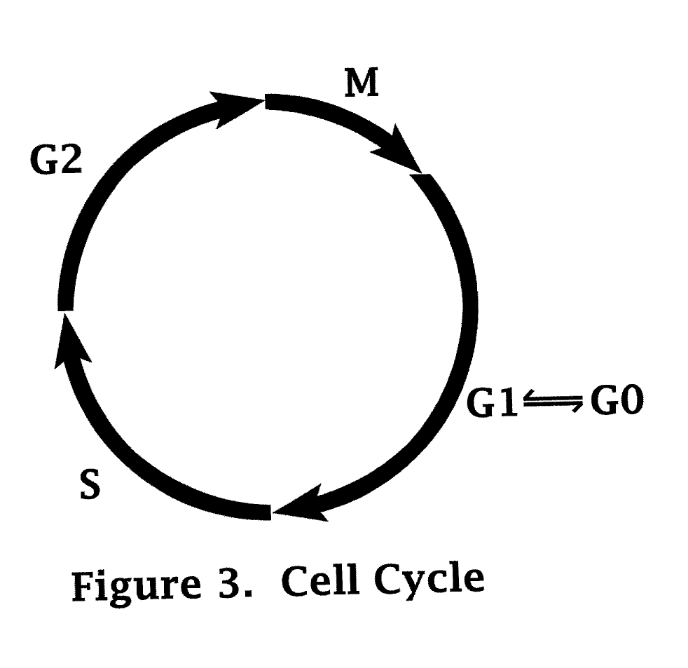

The cell cycle consists of a cyclical progression of states that a cell undergoes during the process of proliferation through cell division. As shown in FIG. 3, there are four phases of the cell cycle: G1, S, G2, and M. G1 and G2 are the so-called gap or growth phases, during which organelles are duplicated and the cell increases in size prior to mitosis. DNA synthesis takes place during the Synthesis or S phase. And mitosis takes place during the M phase, when the chromosomes segregate into the two daughter cells. Collectively, G1, S, and G2 phases are referred to as interphase. Cells that are quiescent (i.e., not growing) are said to be in the G0 phase. The duration of yeast cell cycles is typically around 90 minutes. Somatic cells of higher plants and animals have much longer cell cycles, varying in duration from 10 to 24 hours (or more). In rapidly dividing human cells, a complete cell cycle takes around 24 hours—with about 12 hours in the G1 stage, about 6 hours each in the S and G2 stages, and about 30 minutes in the M stage.

The overlay method is particularly suited to modeling the impact of gene expression on cell-cycle dependent processes. One could first develop a general cell model, and then utilize experimental gene-expression data collected during the various cell-cycle phases to produce overlays that correspond to CBMs applicable during the states G1, S, G2, and M. The process of constructing and applying such overlays is described in further detail below:

1. Constructing A Base Model

As noted above, the overlay method is not applicable to de novo generation of models. Rather, a starting model must be generated using traditional modeling methods or automated model generation techniques. Recently, various automated techniques have been developed to deduce certain relations between various gene products and proteins using clustering, self-organizing maps, two-hybrid protein binding, or other methods, as described in more detail above. In addition, new techniques to streamline and automate model generation have recently been developed, such as the automated technique for extracting functional relationships between cellular components from gene and text-based databases described in Tor-Kristian Jenssen et al., “A Literature Network of Human Genes for High-Throughput Analysis of Gene Expression,” Nature Genetics, vol. 28, pp. 21-28 (2001).

For purposes of the present invention, it is not necessary that the initial model be generated using any particular methodology or be of any particular scope. Hence, the overlay method can be applied to a wide range of existing CBMs.

The base model may be some general representation of the cell or a subset of the total cell (i.e., the biochemical pathways or cellular processes of interest). Such a generalized cell model may not take into account cell-cycle dependent variables or the cell-cycle state. Alternatively, the base model may be a model of the cell during a particular cell cycle phase such as the G1 phase.

2. Collecting Relevant Gene Expression Data

If the base model used is generalized with respect to the cell cycle, then one must consider cell-cycle dependent effects on a subset of model components. In a preferred embodiment of the invention, the cell cycle dependent components would be modeled based upon experimental gene-expression data.

Data relating to the effect of the cell cycle on all genes (or, more specifically, on open-reading frames) in yeast has been published: Paul T. Spellman et al. “Comprehensive Identification of Cell Cycle-Regulated Genes of the Yeast Saccharomyces cerevisiae by Microarray Hybridization,” Molecular Biology of the Cell, vol. 9, pp. 3273-97 (1998). The data is accessible on the internet at the website for the Yeast Cell Cycle Analysis Project: http://cellcyclewww.stanford.edu. Alternatively, such data may be generated using gene chip arrays that are currently available from commercial manufacturers such as Affymetrix (http://www.affymetrix.com). The gene chip could contain a standard set of genes or could be custom designed to contain the relevant genes that correspond to the genes that code for the relevant proteins represented in the base model.

3. Data Preprocessing

If the chip contains a standard set of genes, then the initial preprocessing step would include sorting out the genes that are relevant to the system of interest. This step can be automated if one can extract from the model a table of genes that correspond to the model components.

The next preprocessing step is to eliminate genes with expression levels that do not vary across the different cell cycle states by more than a predefined threshold. Because overlays store information relating to differences between models, there is no reason to store information on components that are unchanged (or relatively unchanged) between the models.

In the next step, in one embodiment, the base model is modified (or created) to correspond to state G1. It is logical to assign state G1 as the default model because, in the absence of experimental manipulation, the largest population of a group of dividing cells is in state G1. Moreover, state G1 is closest to state G0, the quiescent state (an arrested state that prevents cell division typically when the cell is starved of nutrients). The G1 state is also the easiest to produce experimentally. Various methods exist for synchronizing a cell in G1, including α factor arrest, elutriation of the smallest cells, and arrest of a cdc15 temperature-sensitive mutant. See Paul T. Spellman et al., “Comprehensive Identification of Cell Cycle-Regulated Genes of the Yeast Saccharomyces cerevisiae by Microarray Hybridization,” Molecular Biology of the Cell, vol. 9, pp. 3273-97 (1998). While each such method likely produces certain artifacts, redundant information could be collected using different methods to produce a consensus picture of the default cell in G1 phase.

4. Computing Changes In Gene Expression From Default Pattern

Expression data must be collected from a population of cells in each of the four states. Assuming current techniques are used, the gene arrays will report the differential expression level for each gene with respect to the value of the same gene in the G1 data. For example, assume that the gene-array reports a 50% repression of gene CLN2 during the M phase. Accordingly, this gene would be assigned a weight of 0.5 for the M phase given that it is expressed at 50% of the value of the gene-expression level during phase G1. This process is repeated for all genes that are differentially expressed during the three cell cycle phases M, G2, and S (relative to phase G1). Note that the example here is simplified. In practice, some degree of averaging across experimental runs at each phase may be necessary to achieve reliable results given the poor signal-to-noise ratios of existing gene array technologies. However, the process of assigning weights to genes based on reported expression ratios remains essentially as described; and any modifications to the process would be within the skill of the ordinary artisan.

5. Generating Overlays

Overlays are constructed by changing model components that correspond to the differentially expressed genes (in accordance with the assigned weight). For example, if a particular gene codes for an enzyme known to catalyze a specific reaction, then the reaction rate for the conversion of reactant species to products can be adjusted according to the weight (e.g., 50% decrease in that gene produces a net reaction rate that is 50% of the base model rate).

As just described, such an adjustment might entail a simple scaling of the magnitude of some model components. However, a more accurate method would involve the modification of components using knowledge stored with the model components in a database. For example, if the reaction of interest is known to be limited by the amount of substrate present, and not by the amount of enzyme, then the over-expression of the gene coding for this enzyme will be assumed to have minimal or no effect. On the other hand, repression (or under-expression) of this gene would produce less of the enzyme and could potentially change the reaction kinetics such that the reaction rate is limited by the enzyme concentration, not the reactant concentration alone. Such modifications to model components must be made to each model component at a given cell cycle state to generate an overlay. Distinct overlays must be generated for each of the three cell cycle phases M, G2, and S.

### EXAMPLE 3

### Incorporating Gene-expression Data into a Cardiac Model

It is known that cardiac function is affected by gene expression in cardiac cells. Indeed, there have been recent attempts to develop computation models of cardiac cells to predict, albeit in a limited way, the effects produced by altered gene regulation.

For example, in R. L. Winslow et al. “Mechanisms of Altered Excitation-Contraction Coupling In Canine Tachycardia-Induced Heart Failure II: Model Studies,” Circ. Res., vol. 84, pp. 571-86 (1999), the authors report that alteration of two calcium-transport mechanisms could account for observed physiological changes in heart failure in canine myocytes. Specifically, the sodium-calcium exchanger flux is unregulated while uptake into the sarcoplasmic reticulum via SERCA pumps is down-regulated. Together these changes produced a reduced-amplitude, but prolonged, intracellular calcium transient as observed experimentally. In this particular study, model parameters in a computational model were adjusted to match various experimental estimates from both physiological measurements and protein content that was measured in a companion study, as described in O'Rourke et al., “Mechanisms of Altered Excitation-Contraction Coupling In Canine Tachycardia-Induced Heart Failure I: Experimental Studies,” Circ. Res., vol. 84, pp. 562-70 (1999).

The above-described study illustrates the overall feasibility of modifying existing CBMs based upon data relating to differential changes in gene expression and/or protein level. Notably, the overlay method provides significant advantages over the approach utilized in the Winslow study, wherein the modifications to the model were accomplished by ad hoc “hand-tuning,” rather than automatically generated based upon the experimental data. In contrast to the manual parameter adjustments performed by the Winslow group, overlays may be generated directly from the experimental data using an automated process. Moreover, the overlay method is more flexible and extensible (e.g., a single overlay can be applied to multiple models and multiple overlays can be applied to a single model).

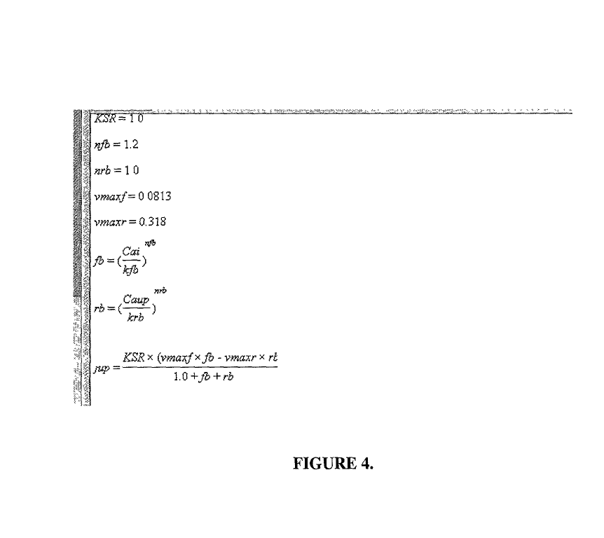

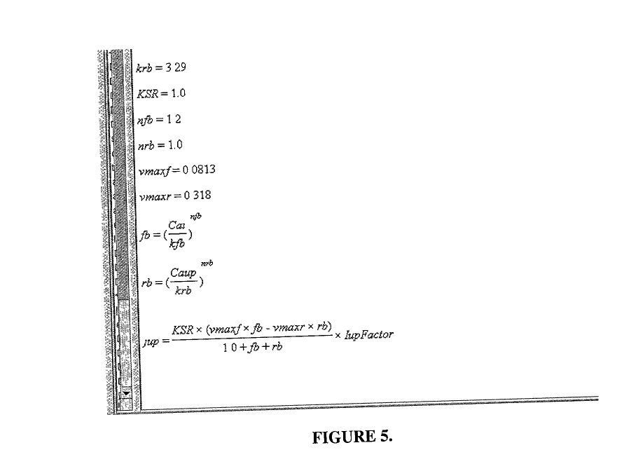

The following example illustrates how the overlay method can be used to modify a model in an efficient manner and simultaneously make it possible for standard regression or optimization software to automate the adjustment of parameters. FIG. 4 shows a subset of the equations for part of the Winslow model cited above, as displayed by Physiome Sciences In Silico Cell™ modeling software. The investigators suggested that calcium flux in the uptake store was down-regulated. This hypothesis can be incorporated into the model by multiplying the expression for the variable “jup” by a factor IupFactor, as shown in FIG. 5. When the factor has a value of 1.0, the model behaves as if it is unmodified from the original model, shown in FIG. 4. When set to a factor between 0.0 and 1.0, the model represents simple down-regulation; and when the factor is set to values greater than 1.0, the model represents simple up-regulation by a fixed fraction.

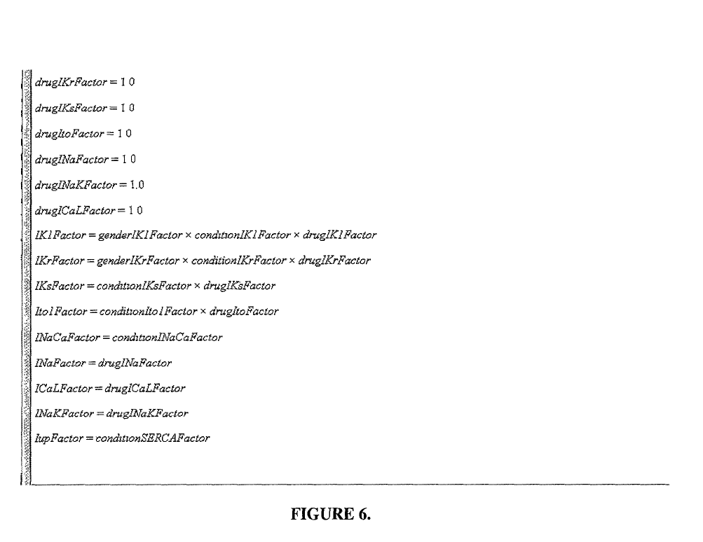

The equations that initialize the value of IupFactor are shown in FIG. 6, where default values of 1.0 are shown. IupFactor, in essence, defines a family of models (i.e., one model for each value of IupFactor).

Winslow used a manual, trial-and-error process of adjusting the parameter values until the model fit the experimental data, but standard nonlinear regression software can be used to find an optimal value of IupFactor that fits the experimental data. This can be accomplished using regression packages such as that found in the IMSL libraries from Visual Numerics, Inc., together with simulation tools, such as In Silico Cell™ modeling software.

Notably, the In Silico Cell™ software package represents models in MathML, a plain-text Extensible Markup Language (XML), which represents mathematical equations that can be translated into simulations or rendered as mathematical expressions. The advantages of using MathML content markup to mark-up algorithms is described in J. Li & G. S. Lett, “Using MathML to Describe Numerical Computations,” MathML International Conference 2000 (Oct. 20, 2000). See http://www.mathmlconference.org/Talks/li/. The following shows the MathML representation for the equation defining jup in the model shown in FIG. 4.

<math>

<RELN>

<EQ/>
<CI other=“extension”>jup</CI>
<APPLY>

<TIMES/>
<APPLY>

<DIVIDE/>
<APPLY>

<TIMES/>
<CI>KSR</CI>
<APPLY>

<MINUS/>
<APPLY>

<TIMES/>
<CI>vmaxf</CI>
<CI>fb</CI>

</APPLY>
<APPLY>

<TIMES/>
<CI>vmaxr</CI>
<CI>rb</CI>

</APPLY>

</APPLY>

</APPLY>
<APPLY>

<PLUS/>
<CN>1.0</CN>
<CI>fb</CI>
<CI>rb</CI>

</APPLY>

</APPLY>
<CI>IupFactor</CI>

</APPLY>

</RELN>

</math>

The following shows a similar MathML expression for the corresponding equation from FIG. 5.

<math>

<reln>

<eq/>
<ci other=“extension”>jup</ci>
<apply>

<divide/>
<apply>

<times/>
<ci>KSR</ci>
<apply>

<minus/>
<apply>

<times/>
<ci>vmaxf</ci>
<ci>fb</ci>

</apply>
<apply>

<times/>
<ci>vmaxr</ci>
<ci>rb</ci>

</apply>

</apply>

</apply>
<apply>

<plus/>
<cn>1.0</cn>
<ci>fb</ci>
<ci>rb</ci>

</apply>

</apply>

</reln>

</math>

Since MathML is a plain-text format, standard text-manipulation software, such as the “diff” routines found in the standard POSIX libraries, can be used to generate the overlay. The output of “diff” can be used by other packages to create multiple documents from a single document and multiple diff outputs. The output of the UNIX “diff” command applied to the above text strings would look like this:

5a6 , 7
> <TIMES/>
> <APPLY>
30a33 , 34
> <CI>IupFactor</CI>
> </APPLY>

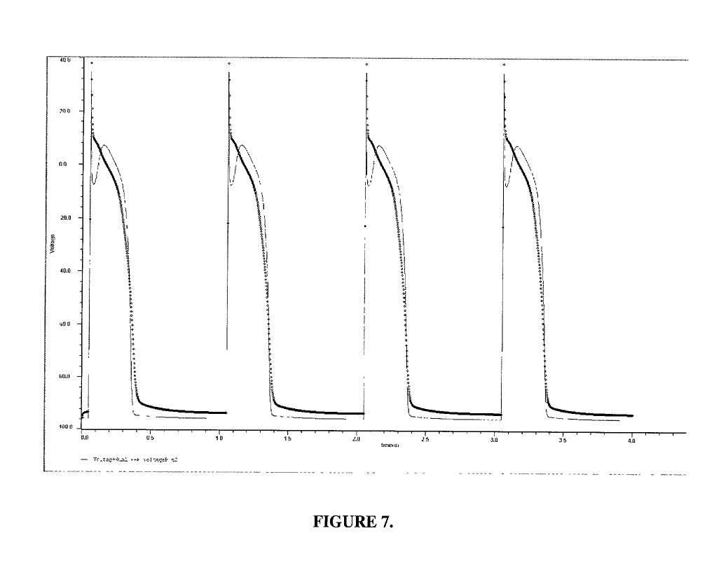

This notation is much more compact than storing the entire text of the new model. Once software, such as the In Silico Cell™ modeling platform, has applied the differences to generate new models, the software can then translate the model into a simulation of the behavior of cardiac cell function. FIG. 7 shows a graph of the cell membrane voltage represented by a healthy (solid curve) and post-heart-failure conditions (dotted curve) of corresponding to the models depicted in FIGS. 4 and 5 respectively.

The foregoing descriptions of specific embodiments of the present invention are presented for purposes of illustration and description. They are not intended to be exhaustive or to limit the invention to the precise forms disclosed; indeed, many modifications and variations are possible in view of the above teachings. The embodiments were chosen and described in order to explain the principles of the invention and its practical applications, and to thereby enable others skilled in the art to utilize the invention in its various embodiments with various modifications as are best suited to the particular use contemplated. Therefore, while the invention has been described with reference to specific embodiments, the description is illustrative of the invention and is not to be construed as limiting the invention. In fact, various modifications and amplifications may occur to those skilled in the art without departing from the true spirit and scope of the invention as defined by the subjoined claims.

All publications, patents and patent applications mentioned in this specification are herein incorporated by reference to the same extent as if each individual publication or patent application were specifically and individually designated as having been incorporated by reference.

We claim:

1. A method for storing multiple computational biological models, said method comprising:
a. selecting a base model from a plurality of computational biological models;
b. computing an overlay for each computational biological model other than the base model;
c. storing said base model; and
d. storing said overlays.

2. The method of claim 1 wherein said base model is selected in order to minimize total storage requirements.

3. The method of claim 1 wherein said base model is selected in order to maximize the number of common model components shared by the base model and the other computational biological models.

4. The method of claim 1 wherein at least one of said overlays is computed by differencing the computational biological model corresponding to said overlay from said base model.

5. The method of claim 1 wherein said computational biological models have been ordered into a defined series, and each overlay is computed by differencing its corresponding computational biological model from the prior computational biological model in the series.

6. A method for quantitative or semi-quantitative modeling of a biological or physiological system, said method comprising:
a. applying one or more overlays to a base computational biological model to generate a second computational biological model; and
b. running a predictive simulation of said second computational biological model.

7. A method for quantitative or semi-quantitative modeling of a biological or physiological system, said method comprising:
a. retrieving a base computational biological model;
b. retrieving an overlay;
c. applying said overlay to said base model to generate a new computational biological model; and
d. running a simulation of said new model on a computer.

8. A method in accordance with claims 6 or 7 wherein said base model is created using traditional modeling methods.

9. A method in accordance with claims 6 or 7 wherein said base model is created using automated model generation techniques.

10. A method in accordance with claim 6 or 7, further comprising the steps of: running a predictive simulation of said base model; and comparing the results of the base-model simulation with the results of the simulation of said second computational biological model.

11. A method for creating an overlay comprising:
a. constructing a base computational biological model;
b. constructing a second computational biological model;
c. comparing the second model with the base model to ascertain the differences between the two models; and
d. computing an overlay based upon the differences between the two models.

12. The method of claim 11 wherein said comparison of the two models is performed at the character-by-character or byte-by-byte level.

13. The method of claim 11 wherein said comparison of the two models is performed at a level of abstraction that reveals true structural or biologically significant differences.

14. The method of claim 11 wherein said second model is constructed by adjusting said base model based upon experimental data.

15. The method of claim 14 wherein said second model construction step includes minimizing an error metric measuring the difference between the predictions made by said second model and said experimental data.

16. The method of claim 15 wherein said error metric is the L2 norm.

17. The method of claim 15 wherein said error-minimization step comprises applying a batch estimator.

18. The method of claim 15 wherein said error-minimization step comprises applying a recursive filter.

19. The method of claim 18 wherein said recursive filter is selected from the group of filters consisting of the least-squares filter, the pseudo-inverse filter, the square-root filter, the Kalman filter, the particle filter, and Jazwinski's adaptive filter.

20. The method of claim 18 wherein said filter is a fading-memory filter.

21. The method of claim 20 wherein said filter is a Kalman-type filter.

22. The method of claim 21 wherein said filter is an extended Kalman filter or an unscented Kalman filter.

23. A method for creating an overlay comprising:
a. obtaining information or data relevant to a base computational biological model; and
b. computing an overlay based upon the model changes implied by said information or data.

24. The method of claim 23 wherein said information includes gene-expression data, protein-expression data, or combinations thereof.

25. A method according claims 1, 6, 7, 11 or 23 wherein said base computational biological model comprises a system of algebraic equations, ordinary differential equations, partial differential equations or combinations thereof.

26. A method according claims 1, 6, 7, 11 or 23 wherein said computational biological models are represented as matrices.

27. A method according claims 1, 6, 7, 11 or 23 wherein said overlays are represented as matrices.

28. An overlay incorporated in a computer readable medium created in accordance with the method of claims 15 or 23.

29. The overlay of claim 28, wherein said overlay is represented in an XML format.

30. The overlay of claim 29 wherein said XML format is CellML.

31. An overlay incorporated in a computer readable medium comprising: means to operate on a computational biological model to introduce at least one change in said model.

32. The overlay of claim 31, wherein said overlay is represented in an XML format.

33. The overlay of claim 32 wherein said XML format is CellML.

34. A system for storing multiple computational biological models, said system comprising:
a. means for selecting a base model from a plurality of computational biological models;
b. means for computing an overlay for each computational biological model other than the base model;
c. means for storing said base model; and
d. means for storing said overlays.

35. The system of claim 34 wherein said base model is selected in order to minimize total storage requirements.

36. The system of claim 34 wherein said base model is selected in order to maximize the number of common model components shared by the base model and the other computational biological models.

37. The system of claim 34 wherein at least one of said overlays is computed by differencing the computational biological model corresponding to said overlay from said base model.

38. The system of claim 34 wherein said computational biological models have been ordered into a defined series, and each overlay is computed by differencing its corresponding computational biological model from the prior computational biological model in the series.

39. A system for quantitative or semi-quantitative modeling of a biological or physiological system, said system comprising:
a. means for applying one or more overlays to a base computational biological model to generate a second computational biological model; and
b. means for simulating said second computational biological model.

40. A system for quantitative or semi-quantitative modeling of a biological or physiological system, said system comprising:
a. means for retrieving a base computational biological model;
b. means for retrieving an overlay;
c. means for applying said overlay to said base model to generate a new computational biological model; and
d. means for simulating said new model on a computer.

41. A system in accordance with claims 39 or 40 wherein said base model is created using traditional modeling methods.

42. A system in accordance with claims 39 or 40 wherein said base model is created using automated model generation techniques.

43. A system in accordance with claims 39 or 40, further comprising the steps of: running a predictive simulation of said base model; and comparing the results of the base-model simulation with the results of the simulation of said second computational biological model.

44. A system for creating an overlay comprising:
a. means for constructing a base computational biological model;
b. means for constructing a second computational biological model;
c. means for comparing the second model with the base model to ascertain the differences between the two models; and
d. means for computing an overlay based upon the differences between the two models.

45. The system of claim 44 wherein said comparison of the two models is performed at the character-by-character or byte-by-byte level.

46. The system of claim 44 wherein said comparison of the two models is performed at a level of abstraction that reveals true structural or biologically significant differences.

47. The system of claim 44 wherein said second model is constructed by adjusting said base model based upon experimental data.

48. The system of claim 47 wherein said second model construction step includes minimizing an error metric measuring the difference between the predictions made by said second model and said experimental data.

49. The system of claim 48 wherein said error metric is the L2 norm.

50. The system of claim 48 wherein said error-minimization step comprises applying a batch estimator.

51. The system of claim 48 wherein said error-minimization step comprises applying a recursive filter.

52. The system of claim 51 wherein said recursive filter is selected from the group of filters consisting of the least-squares filter, the pseudo-inverse filter, the square-root filter, the Kalman filter, the particle filter, and Jazwinski's adaptive filter.

53. The system of claim 51 wherein said filter is a fading-memory filter.

54. The system of claim 53 wherein said filter is a Kalman-type filter.

55. The system of claim 54 wherein said filter is an extended Kalman filter or an unscented Kalman filter.

56. A system for creating an overlay comprising:
a. means for obtaining information or data relevant to a base computational biological model; and
b. means for computing an overlay based upon the model changes implied by said information or data.

57. The system of claim 56 wherein said information includes gene-expression data, protein-expression data, or combinations thereof.

58. A computer program product comprising at least one overlay stored in a computer usable media in a computer readable format.

59. A computer program product loadable into the memory of a computer, said product comprising software code portions for performing the steps of any one of claims 1, 6, 7, 11 or 23 when said product is run on said computer.
